(19) United States
(12) Patent Application Publication
(10) Pub. No.: US 2020/0355627 A1
(43) Pub. Date: Nov. 12, 2020

(54) METHOD FOR DETECTING DISPLAY SCREEN PERIPHERAL CIRCUIT, APPARATUS, ELECTRONIC DEVICE AND STORAGE MEDIUM

(71) Applicant: Beijing Baidu Netcom Science Technology Co., Ltd., Beijing (CN)

(72) Inventors: Yawei WEN, Beijing (CN); Jiabing LENG, Beijing (CN); Minghao LIU, Beijing (CN); Yulin XU, Beijing (CN); Jiangliang GUO, Beijing (CN); Xu LI, Beijing (CN)

(21) Appl. No.: 16/941,610

(22) Filed: Jul. 29, 2020

Related U.S. Application Data
(63) Continuation of application No. PCT/CN2019/085921, filed on May 8, 2019.

(30) Foreign Application Priority Data
Jul. 2, 2018 (CN) 201810710534.1

(51) Int. Cl. G01N 21/956; G06T 7/00; G06T 3/60; G06T 3/40; G06N 3/08; G05B 19/406

(52) U.S. Cl. CPC G01N 21/95607; G06T 7/001; G06T 3/60; G06T 3/40; G08B 21/18; G05B 19/406; G06T 2207/20081; G06T 2207/20084; G06N 3/08

(57) ABSTRACT

The disclosure provides a method for detecting a display screen peripheral circuit, by receiving a quality detection request sent by a console deployed on a production line of the display screen peripheral circuit, where the quality detection request includes an image of the display screen peripheral circuit captured by an image capturing device on the production line of the display screen peripheral circuit; enlarging or reducing the image of the display screen peripheral circuit to obtain an image to be detected, where the defect detection model is obtained by using a historical image of a defective display screen peripheral circuit to perform object detection FAST RCNN algorithm training; inputting the image to be detected into the defect detection model to obtain a defect detection result; and determining, according to the defect detection result, quality of a display screen peripheral circuit corresponding to the image of the display screen peripheral circuit.

### CROSS-REFERENCE TO RELATED APPLICATION

This application is a continuation of International Application No. PCT/CN2019/085921, filed on May 8, 2019, which claims priority to Chinese Patent Application No. 201810710534.1, titled “METHOD FOR DETECTING DISPLAY SCREEN PERIPHERAL CIRCUIT, APPARATUS, ELECTRONIC DEVICE AND STORAGE”, filed on Jul. 2, 2018, by BEIJING BAIDU NETCOM SCIENCE TECHNOLOGY CO., LTD., both of which are hereby incorporated by reference in their entireties.

### TECHNICAL FIELD

The disclosure relates to a defect detection technology, in particular, to a method for detecting a display screen peripheral circuit, an apparatus, an electronic device and a storage medium.

### BACKGROUND

With the development of science and technology, the role of information display technology in people's life is increasing day by day, the display screen is also widely used due to its small size, light weight, low power, high resolution, high brightness and no geometric deformation. However, in the production process of the display screen, defects in the display screen peripheral circuits may occur due to process and environmental reasons, such as point defects, foreign matter defects, and scratch defects. Therefore, the peripheral circuit detection of the display screen is an important part of the production process.

In the prior art, the peripheral circuit detection of the display screen mainly adopts manual detection or machine-assisted manual detection method. Specifically, the manual detection method refers to: an industry expert visually observe pictures captured from production environment and give judgments. The machine-assisted manual detection method refers to: first a quality detection system, which is provided with experience of industry experts, is used to detect the peripheral circuit images of the display screen to be detected, and initially screening out the image suspected of being defective, and then the industry experts manually detect and judge the pictures with suspected defects.

However, both the manual detection method and the machine-assisted manual detection method are affected greatly by subjective factors of humans, and have low detection accuracy, poor system performance and low business scalability.

### SUMMARY

The disclosure provides a method for detecting a display screen peripheral circuit, an apparatus, an electronic device and a storage medium, to overcome a problem that existing display screen peripheral circuit defect detection methods are affected greatly by subjective factor of humans, resulting in low detection accuracy, poor system performance and low business scalability.

A first aspect of the present disclosure provides a method for detecting a display screen peripheral circuit, including:

receiving a quality detection request sent by a console deployed on a production line of the display screen peripheral circuit, where the quality detection request includes an image of the display screen peripheral circuit captured by an image capturing device on the production line of the display screen peripheral circuit;

enlarging or reducing the image of the display screen peripheral circuit to obtain an image to be detected, where a size of the image to be detected is consistent with an input size requirement of a defect detection model, where the defect detection model is obtained by using a historical image of a defective display screen peripheral circuit to perform object detection fast region-based convolutional neural network (FAST RCNN) algorithm training;

inputting the image to be detected into the defect detection model to obtain a defect detection result; and

determining, according to the defect detection result, quality of the display screen peripheral circuit corresponding to the image of the display screen peripheral circuit.

In a possible implementation of the first aspect, before the inputting the image to be detected into the defect detection model to obtain a defect detection result, further including:

performing the FAST RCNN algorithm training on the defect detection model with an actual type of a historical image of the defective display screen peripheral circuit, so that a loss value between a prediction type which is outputted by the defect detection model for the historical image of the defective display screen peripheral circuit and the actual type is lower than a preset loss threshold.

In another possible implementation of the first aspect, before the enlarging or reducing the image of the display screen peripheral circuit, further including:

performing image preprocessing on the image of the display screen peripheral circuit, where the image preprocessing includes one or more of following processes:

trimming, cutting, and rotating.

In yet another possible implementation of the first aspect, the inputting the image to be detected into the defect detection model to obtain a defect detection result, including:

determining a detection model server carrying a processing resource according to a load balancing policy; and

inputting the image to be detected into the defect detection model running on the detection model server to obtain a defect detection result.

In yet another possible implementation of the first aspect, the defect detection result includes: a type of a defect, and/or a marquee position of a defect;

the determining, according to the defect detection result, quality of the display screen peripheral circuit corresponding to the image of the display screen peripheral circuit, including:

determining, according to a production stage information and the defect detection result, the quality of the display screen peripheral circuit corresponding to the image of the display screen peripheral circuit.

In yet another possible implementation of the first aspect, after determining, according to the defect detection result, quality of the display screen peripheral circuit corresponding to the image of the display screen peripheral circuit, further including:

if it is determined that the display screen peripheral circuit is a damaged circuit, performing one or more of following operations:

sending, through a controller, alarm information to a production manager;

storing, through the controller, the defect detection result in a production database as a log;

sending, through the controller, a production control instruction to the console to eliminate a defect; and

inputting the image of the display screen peripheral circuit and the defect detection result into the defect detection model to optimize the defect detection model.

A second aspect of the present disclosure provides an apparatus for detecting a display screen peripheral circuit, including:

a receiving module, configured to receive a quality detection request sent by a console deployed on a production line of the display screen peripheral circuit, where the quality detection request includes an image of the display screen peripheral circuit captured by an image capturing device on the production line of the display screen peripheral circuit;

a preprocessing module, configured to enlarge or reduce the image of the display screen peripheral circuit to obtain an image to be detected, where a size of the image of the display screen peripheral circuit is consistent with an input size requirement of a defect detection model, where the defect detection model is obtained by using a historical image of a defective display screen peripheral circuit to perform object detection FAST RCNN algorithm training;

a processing module, configured to input the image to be detected into the defect detection model to obtain a defect detection result; and

a determining module, configured to determine, according to the defect detection result, quality of the display screen peripheral circuit corresponding to the image of the display screen peripheral circuit.

In a possible implementation of the second aspect, the processing module is further configured to: before the inputting the image to be detected into the defect detection model to obtain a defect detection result, perform the FAST RCNN algorithm training on the defect detection model with an actual type of a historical image of the defective display screen peripheral circuit, so that a loss value between a prediction type which is outputted by the defect detection model for the historical image of the defective display screen peripheral circuit and the actual type is lower than a preset loss threshold.

In another possible implementation of the second aspect, the preprocessing module is further configured to: before the enlarging or reducing the image of the display screen peripheral circuit, perform image preprocessing on the image of the display screen peripheral circuit, where the image preprocessing includes one or more of following processes: trimming, cutting, and rotating.

In yet another possible implementation of the second aspect, the processing module is specifically configured to determine a detection model server carrying a processing resource according to a load balancing policy; inputting the image to be detected into the defect detection model running on the detection model server to obtain a defect detection result.

In yet another possible implementation of the second aspect, the defect detection result includes: a type of a defect, and/or a marquee position of a defect;

the determining module is specifically configured to determine, according to a production stage information and the defect detection result, quality of the display screen peripheral circuit corresponding to the image of the display screen peripheral circuit.

In yet another possible implementation of the second aspect, the processing module is further configured to: after the determining, according to the defect detection result, quality of the display screen peripheral circuit corresponding to the image of the display screen peripheral circuit, if it is determined that the display screen peripheral circuit is a damaged circuit, perform one or more of following operations:

sending, through a controller, alarm information to a production manager;

storing, through the controller, the defect detection result in a production database as a log;

sending, through the controller, a production control instruction to the console to eliminate a defect;

inputting the image of the display screen peripheral circuit and the defect detection result into the defect detection model to optimize the defect detection model.

A third aspect of the present disclosure provides an electronic device including a processor, a memory, and a computer program stored on the memory and operable on the processor, when the processor executes the program, the method of any of the first aspect and the various possible implementations of the first aspect is implemented.

A fourth aspect of the present disclosure provides a storage medium, where the storage medium stores an instruction which, when runs on a computer, causes the computer to perform the method of any of the first aspect and the various possible implementations of the first aspect.

According to the method for detecting a display screen peripheral circuit, the apparatus, the electronic device and the storage medium provided by the present disclosure, by receiving a quality detection request sent by a console deployed on a production line of the display screen peripheral circuit, where the quality detection request includes an image of the display screen peripheral circuit captured by an image capturing device on the production line of the display screen peripheral circuit; enlarging or reducing the image of the display screen peripheral circuit to obtain an image to be detected whose size is consistent with an input size requirement of a defect detection model, where the defect detection model is obtained by performing an object detection algorithm FAST RCNN training on a historical image of a defective display screen peripheral circuit; inputting the image to be detected into the defect detection model to obtain a defect detection result; and determining, according to the defect detection result, quality of the display screen peripheral circuit corresponding to the image of the display screen peripheral circuit. Since the defect detection model is obtained by performing FAST RCNN training on the historical image of a defective display screen peripheral circuit, the defect detection result obtained by using the defect detection model has high classification accuracy and strong intelligence capability, the system performance is improved, and the business scalability is high, which solves the problem that the existing display screen peripheral circuit detection methods are affected greatly by subjective factors of humans, resulting in low detection accuracy, poor system performance and low business scalability.

### BRIEF DESCRIPTION OF THE DRAWINGS

FIG. 1 is a schematic structural diagram of a system for detecting a display screen peripheral circuit according to an embodiment of the present disclosure;

FIG. 2 is a flowchart diagram of a method for detecting a display screen peripheral circuit according to Embodiment I of the present disclosure;

FIG. 3 is a flowchart diagram of a method for detecting a display screen peripheral circuit according to Embodiment II of the present disclosure;

FIG. 4 is a schematic structural diagram of an embodiment of an apparatus for detecting a display screen peripheral circuit according to an embodiment of the present disclosure; and

FIG. 5 is a schematic structural diagram of an embodiment of an electronic device according to an embodiment of the present disclosure.

### DETAILED DESCRIPTION OF THE EMBODIMENTS

In order to make purposes, technical solutions and advantages of the embodiments of the present disclosure clearer, the technical solutions in the embodiments of the present disclosure will be clearly and completely described below in conjunction with the accompanying drawings of the embodiments of the present disclosure. It is apparent that the described embodiments are some embodiments of the present disclosure, and not all embodiments. All other embodiments obtained by those skilled in the art based on the embodiments of the present disclosure without creative efforts are within the scope of the present disclosure.

It should be understood that, in various embodiments of the present disclosure, the size of the sequence number of each process does not mean the order of execution, and the order of execution of each process should be determined by its function and internal logic, and should not constitute any limitation on the implementation process of the embodiments of the present disclosure.

It should be understood that in the present disclosure, the terms “includes” and “have” and any variant thereof are intended to cover a non-exclusive inclusion, for example, a process, method, system, product, or device that includes a series of steps or units is not necessarily limited to those steps or units explicitly listed, but may include other steps or units not explicitly listed or inherent to the process, method, system, product or device.

It should be understood that in the present disclosure, the term “a plurality” means two or more. The term “and/or” is merely an association relationship describing associated objects, indicating that there may be three relationships, for example, A and/or B, which may indicate these three situations that A exists separately, both A and B exist, and B exists separately. In addition, the character “/” herein generally indicates that the back and forth associated object is an “or” relationship.

It should be understood that, in the present disclosure, the expression “B corresponding to A”, “A corresponds to B” or “B corresponds to A”, indicating that B is associated with A, and B may be determined according to A. Determining B according to A does not merely mean that B is determined according to A, and B may also be determined according to A and/or other information. The match between A and B is that the similarity between A and B is greater than or equal to a preset threshold.

Depending on context, the term “if” as used herein may be interpreted as “when” or “while” or “in response to determining” or “in response to detecting”.

At present, the overall intelligent automation of the 3C industry (3C industry refers to the information appliance industry that integrates the application of computer, communication, and consumer electronics) is low. It can be seen from the investigation and analysis on the industry of display screens, such as mobile phone screens, the detection methods for mobile phone screen used by most of manufacturers can be divided into two types, namely: manual detection method and machine-assisted manual detection method.

The manual detection method refers to: an industry expert visually observe images captured from production environment and give judgements. This method is affected greatly by subjective factors of humans, has low detection efficiency, and does great harm to human eyes. In addition, since production workshop of display screen is generally a dust-free environment, staffs need to prepare for cleaning before entering, and wearing dust-free clothes, which may also adversely affect the health and safety of the staffs.

The machine-assisted manual detection method can also be called a detection method based on a liquid crystal module detection device, and the specific principle is: firstly, a quality detection system with certain judgment ability filters out images without defects, and then an industry expert detect and judge images with suspected defects. In the machine-assisted manual detection method, the quality detection system is mostly developed from the expert system and the characteristic engineering system, it means that the expert experience is solidified in the quality detection system, so that it has certain automation ability. Therefore, the machine-assisted manual detection method has low accuracy and poor system performance, and cannot cover all detecting standards of the manufacturer. Moreover, this method is also inefficient and easy to miss and misjudge defects, and the image data after detection is difficult to be used for secondary exploitation. In addition, in the aforementioned quality detection system, the characteristics and judgment rules are solidified into the machine according to the experience of the industry expert, and it is difficult to iterate with the development of the business, resulting in that the detection accuracy of the quality detection system becomes lower and lower with the development of the production process, and may even be reduced to a state of being completely unusable. In addition, the characteristics of the quality detection system are pre-solidified in hardware by third-party suppliers, and when upgrading, the production line needs to be substantially transformed, and the cost is very high, and it has obvious deficiencies in terms of safety, standardization and scalability, which is not conducive to the optimization and upgrading of the display screen production line, and the business scalability is low.

In summary, both the manual detection method and the machine-assisted manual detection method have the following disadvantages: not only inefficient, but also prone to misjudgment, and the industrial data generated by the two methods is not easy to store, manage, and re-excavate.

The embodiments of the present disclosure develop an automatic, high-precision, adaptive correction and upgrade display screen peripheral circuit detection method based on the latest development of artificial intelligence technology in computer vision, using an image of the display screen peripheral circuit captured by an image capturing device in real time on a production line of the display screen peripheral circuit, and detecting and judging surface quality of the display screen peripheral circuit in real time, if it is detected that there is a defect in a current image of the display screen peripheral circuit captured by the image capturing device, a marquee position in a picture of each defect and type of the defect are determined, and the embodiments of the present disclosure do not distinguish defective individuals from the same type of defects.

In an embodiment, the defects described in the embodiments of the present disclosure may include, but are not limited to, different types of defects including point defects, foreign matter defects, and scratch defects. No one is introduced here.

It should be understood that in the present disclosure, an object detection FAST RCNN algorithm is built on a previous deep convolutional neural network for effective classification and target detection. Object detection by FAST RCNN can locate a bounding box of an object. For example, in an image with a defect, not only the boundary box of the defect can be located (usually indicated by a marquee), but also the object inside the bounding box can be recognized as a certain type of defect. The marquee position of the defect in the present disclosure refers to a boundary box position where a defect is located. For example, if a scratch defect is framed by a red frame in an image to be detected, it indicates that the framed area is the position of the scratch defect, and the red frame corresponds to the scratch defect. Other types of defects may be indicated by other different colors.

Technical solutions of the present disclosure are described in detail below through specific embodiments. Following specific embodiments may be combined with each other, and the same or similar concepts or processes may not be repeated in some embodiments.

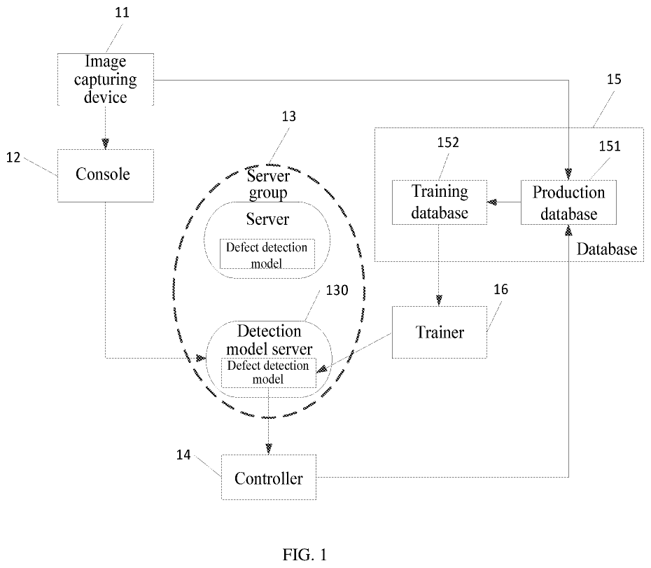

Following is a brief description of an application scene to which the embodiments of the present disclosure are applied. Referring to FIG. 1, FIG. 1 is a schematic structural diagram of a system for detecting a display screen peripheral circuit according to an embodiment of the present disclosure. In the system shown in FIG. 1, the method for detecting a display screen peripheral circuit provided by the present disclosure is applied to perform defect detection on the display screen peripheral circuit. As shown in FIG. 1, the system for detecting the display screen peripheral circuit mainly includes: a console 12, a server group 13, a controller 14, a database 15, a trainer 16, and an image capturing device 11 deployed on a production line of the display screen peripheral circuit.

The image capturing device 11 captures an image of the display screen peripheral circuit on a display circuit peripheral circuit production line, the console 12 receives the image of the display screen peripheral circuit acquired by the image capturing device 11, and sends the image of the display screen peripheral circuit to the detection model server 130 in the server group 13, the detection model server 130 inputs the received image of the display screen peripheral circuit into a defect detection model that runs on the detection model server 130 to obtain a defect detection result, the controller 14 receives the defect detection result of the detection model server 130, and gives a service response in combination with production stage information, and the controller 14 can also store the defect detection result in the database 15 as a log. In addition, the image of the display screen peripheral circuit captured by the image capturing device 11 can also be directly stored in the database 15 as a raw data for training the defect detection model. The trainer 16 extracts a historical image of a defective display screen peripheral circuit in the database and obtains the defect detection model based on the FAST RCNN algorithm training.

In an embodiment, the database 15 may include a production database 151 and a training database 152, the production database 151 can receive and save the defect detection result sent by the controller 14 and the image of the display screen peripheral circuit captured by the image capturing device 11, the training database 152 can store the historical image of the defective display screen peripheral circuit extracted from the production database 151 and a corresponding original image of the display screen peripheral circuit, so that the trainer 16 can obtain a defect detection model with high detection accuracy by training.

In an embodiment, the trainer 16 in the embodiment of the present disclosure may be a training engine implemented by hardware and/or software functions, as a training tool for the defect detection model. The system for detecting the display screen peripheral circuit of the embodiments of the present disclosure may further include other physical modules such as a processor and a memory, and the embodiment is not limited thereto.

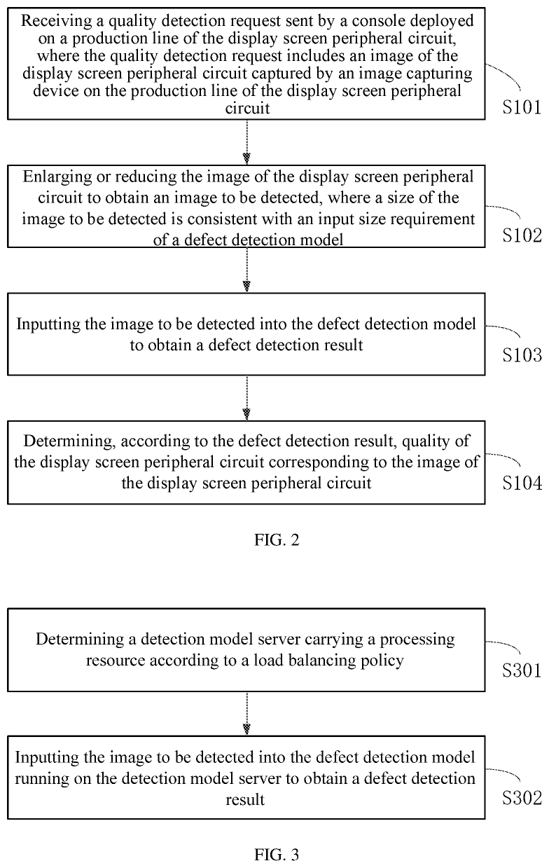

FIG. 2 is a flowchart diagram of a method for detecting a display screen peripheral circuit according to Embodiment I of the present disclosure, the execution body of the method shown in FIG. 2 may be a software device, a hardware device, or a combination of software and hardware. Steps S101 to S104 are included, as follows:

S101, receiving a quality detection request sent by a console deployed on a production line of the display screen peripheral circuit, where the quality detection request includes an image of the display screen peripheral circuit captured by an image capturing device on the production line of the display screen peripheral circuit.

In the embodiment of the present disclosure, the production line of the display screen peripheral circuit can be deployed with multiple different devices, such as an image capturing device, a console, a server group, a controller, a database. The image capturing device can be a high precision image capturing camera, and in a production process of the display screen peripheral circuit, it is possible to capture a plurality of images of the display screen peripheral circuit corresponding to the display screen peripheral circuits which are in the production process, by adjusting the angle, light, filter, zoom lens, focus, etc. of the image capturing device.

After the image of the display screen peripheral circuit is captured by the image capturing device on the production line of the display screen peripheral circuit, the console deployed on the production line of the display screen peripheral circuit can send a quality detection request to the server group on which the defect detection model is deployed on the production line of the display screen peripheral circuit, the quality detection request includes the image of the display screen peripheral circuit captured by the image capturing device, so that a server that receives the quality detection request in the server group processes the received image of the display screen peripheral circuit.

S102, enlarging or reducing the image of the display screen peripheral circuit to obtain an image to be detected, where a size of the image to be detected is consistent with an input size requirement of a defect detection model.

S103, inputting the image to be detected into the defect detection model to obtain a defect detection result.

The defect detection model is obtained by using a historical image of a defective display screen peripheral circuit to perform object detection FAST RCNN algorithm training. The defect detection model obtained by the object detection FAST RCNN training has a size requirement for the input image. Once the size of the input image is inconsistent with the input size requirement of the model, the input image cannot be processed by the defect detection model. When the display screen peripheral circuit is detected, the line orientation and winding shape indicated by the global image can better represent its possible defects, therefore, in the embodiment, an image of the display screen peripheral circuit is first scaled so that the size of the image to be detected is consistent with the input size requirement of the defect detection model before inputting into the defect detection model.

Enlarging or reducing the image of the display screen peripheral circuit can be understood as enlarging or reducing with the pixel unchanged, and can also be understood as enlarging or reducing with pixel reduction. If the pixel is too high, processing capability of the defect detection model may be exceeded. Therefore, if the pixel of the image of the display screen peripheral circuit is too high, it is also possible to perform pixel-down processing on the image of the display screen peripheral circuit first, which is not limited herein.

In an embodiment, a server that receives the quality detection request acquires the image of the display screen peripheral circuit in the quality detection request, and performs preprocessing of enlargement or reduction to obtain an image to be detected whose size is consistent with the input size requirement of the defect detection model. Then, the image to be detected is input into the defect detection model running on the server, and defect detection is performed by the defect detection model, thereby the defect detection result is obtained.

In an implementation, image of the display screen peripheral circuit can also be preprocessed before the enlargement or reduction of the image of the display screen peripheral circuit, where the image preprocessing includes one or more of following processes: trimming, cutting, and rotating. It can be understood that the image capturing device deployed on the production line of the display screen peripheral circuit is generally a high-precision camera, therefore, the image of the display screen peripheral circuit captured by the image capturing device may have a large size, or a high pixel, or an inappropriate position. Therefore, after the image of the display screen peripheral circuit included in the quality detection request sent by the console is received, the image of the display screen peripheral circuit needs to be preprocessed according to actual conditions. For example, if the edge area of the image of the display screen peripheral circuit is large, the image of the display screen peripheral circuit may be trimmed to retain the useful part of the image of the display screen peripheral circuit.

It is worth noting that the defect detection model running on the server is obtained by performing the object defect detection FAST RCNN algorithm training on the historical image of the defective display screen peripheral circuit. Specifically, the FAST RCNN algorithm is used for object detection in the embodiment. Object detection refers to letting the computer detect according to what object is in the image, that is, whether the image to be detected contains defects and the type of defects when the defect is included are identified. In the embodiment of the present disclosure, the defect detection model uses FAST RCNN structure. Specifically, the image of the display screen peripheral circuit of the production line of the display screen peripheral circuit is used as an input of the defect detection model, and the FAST RCNN structure of the defect detection model is used to identify characteristics of the image of the display screen peripheral circuit, that is, to obtain which images in the image to be detected are normal images without defects, and which images are defective images with defects, and for the defective image, it also can identify the type of defect included in the image, and determine the marquee position where the defect is located by using the bounding box.

As an example, before the inputting the image of the display screen peripheral circuit into the defect detection model to obtain a defect detection result, a model training process may also be included. Specifically, it can be performing the FAST RCNN algorithm training on the defect detection model with the actual type of the historical image of the defective display screen peripheral circuit, so that a loss value between a prediction type which is outputted by the defect detection model for the historical image of the defective display screen peripheral circuit and the actual type is lower than a preset loss threshold.

The loss value can be understood as a total loss value, the defect detection model is a result that performing combined training on a candidate region loss value, a region type loss value, and a region boundary loss value of the historical defect display image, so that the total loss value of the candidate region loss value, the region type loss value, and the region boundary loss value satisfy a preset loss threshold. The candidate region loss value refers to a loss value between a selected defect region and an actual defect region in the historical image of the defective display screen, the area type loss value refers to a loss value between a predicted defect type and an actual defect type in the selected defect area, the region boundary loss value refers to a loss value between a predicted defect boundary and an actual defect boundary in the selected defect region.

The embodiments of the present disclosure can utilize the FAST RCNN model, which have high robustness to deformation, blur, and illumination changes of the image of the display screen peripheral circuit captured by the image capturing device on the production line of the display screen peripheral circuit, and has higher generalization for classification tasks.

It is worth noting that, in the embodiment of the present disclosure, for different production scenes and characteristics of the image of the display screen peripheral circuit, the FAST RCNN model required to train the defect detection model may be organized differently, which may be determined according to actual conditions, and it is not limited in this embodiment.

S104, determining, according to the defect detection result, quality of a display screen peripheral circuit corresponding to the image of the display screen peripheral circuit.

In the embodiment of the disclosure, after the defect detection result is obtained according to the defect detection model, quality of the display screen peripheral circuit corresponding to the image of the display screen peripheral circuit may be determined according to the defect detection result.

In an embodiment of the disclosure, the defect detection result may include: a type of a defect, and/or a marquee position of each defect. For example, when there is a defect in the image of the display screen peripheral circuit, the defect detection result that can be obtained by the defect detection model may include types of the defects (how many types of defects exist on the display screen peripheral circuit), and marquee positions of the defects (the position of each defect is indicated by a marquee). The way in which the defect detection result is presented can be understood as, the defect detection model outputs a characteristic pattern with a marquee, and the marquee frames and displays a defect contained in the image to be detected, and the marquee corresponds to a result of a type of the defect. The position of the defect in the image of the display screen peripheral circuit can be determined by the position of the marquee.

Correspondingly, S104 (determining, according to the defect detection result, quality of the display screen peripheral circuit corresponding to the image of the display screen peripheral circuit) may be replaced by: determining, according to production stage information and the defect detection result, quality of the display screen peripheral circuit corresponding to the image of the display screen peripheral circuit.

Specifically, various production stage information such as manufacturer, production environment, and type of the display screen peripheral circuit may obtain different defect detection results in the display screen peripheral circuit detection process. For different types of display screen peripheral circuits, the production stages they experience are different, therefore, when analyzing the defect detection result obtained above, it is necessary to combine the production stage information of each display screen peripheral circuit to determine the quality of the display screen peripheral circuit.

It is worth noting that, the defect detection model of the embodiment of the present disclosure can detect the types of the defects in the image of the display screen peripheral circuit, and the marquee position of each type of defect, without identifying the specific defect contour and the defect individual, thereby reducing the operation load.

The method for detecting the display screen peripheral circuit provided by the embodiment of the present disclosure, by receiving a quality detection request sent by a console deployed on a production line of the display screen peripheral circuit, the quality detection request includes an image of the display screen peripheral circuit captured by an image capturing device on a production line of the display screen peripheral circuit, inputting the image to be detected into the defect detection model to obtain a defect detection result, and determining, according to the defect detection result, quality of the display screen peripheral circuit corresponding to the image of the display screen peripheral circuit. Since the defect detection model is obtained by performing the FAST RCNN algorithm training on the historical image of a defective display screen peripheral circuit, the defect detection result obtained by the defect detection model has high classification accuracy, and strong intelligence capability, the system performance is improved, and the business scalability is high.

FIG. 3 is a flowchart diagram of a method for detecting a display screen peripheral circuit according to Embodiment II of the present disclosure. Based on the embodiment, in the embodiment shown in FIG. 3, the S104 (inputting the image to be detected into the defect detection model to obtain a defect detection result) can be implemented by using steps S301-S302, as follows:

S301, determining a detection model server carrying a processing resource according to a load balancing policy.

In the embodiment of the disclosure, a server group is deployed on the production line of the display screen peripheral circuit, the number of servers in the server group can be multiple, each of which runs a defect detection model. In an embodiment, the defect detection model running on each server is the same. Therefore, each server can receive the quality detection request sent by the console, so that the quality detection can be performed on an image of the display screen peripheral circuit by using the defect detection model carried by itself.

As an example, since the image capturing device deployed on the production line of the display screen peripheral circuit captures the image of the display screen peripheral circuit in real time, the console can also send a quality detection request to any server in the server group in real time.

In an embodiment, since the defect detection model running on each server in the server group is the same, in order to improve the detection efficiency of the defect detection model on the server, and ensure load balancing of the defect detection model, a server can be determined, according to a preset load balancing policy, from the server group as a detection model server carrying the processing resource, that is, load balancing and scheduling can be performed in real time according to the deployment situation of the defect detection model on the production line of the display screen peripheral circuit.

S302, inputting the image to be detected into the defect detection model running on the detection model server to obtain a defect detection result.

In the embodiment of the present disclosure, after determining the detection model server carrying the processing resource from the server group, the image of the display screen peripheral circuit may be input to the defect detection model running on the detection model server, defect of the image of the display screen peripheral circuit is detected by using the defect detection model, then the defect detection result is obtained. In an embodiment, the defect detection model is obtained training a preset type and an actual type of the historical image of a defective display screen peripheral circuit by the training module.

The method for detecting the display screen peripheral circuit provided by the embodiment of the present disclosure, by determining a detection model server carrying a processing resource according to a load balancing policy, and inputting the image to be detected into a defect detection model running on the detection model server to obtain a defect detection result, which can achieve load balancing on the server, improve detection efficiency of the image of the display screen peripheral circuit, and improve the performance of the system for detecting the display screen peripheral circuit.

In an implementation, after the S302 (inputting the image to be detected into a defect detection model running on the detection model server to obtain a defect detection result), can also include following steps:

if it is determined that the display screen peripheral circuit is a damaged circuit, performing one or more of following operations:

sending, through a controller, alarm information to a production manager;

storing, through the controller, the defect detection result in a production database as a log;

sending, through the controller, a production control instruction to the console to eliminate a defect;

inputting the image of the display screen peripheral circuit and the defect detection result into the defect detection model to optimize the defect detection model.

In embodiments of the present disclosure, the tester can pre-set a solution when determining the display screen peripheral circuit as a damaged screen according to production scenes and production stage information of the display screen peripheral circuit, for example, sending, through a controller, alarm information to a production manager, and/or storing, through the controller, the defect detection result in a production database as a log, and/or sending, through the controller, a production control instruction to the console to eliminate a defect, and/or, inputting the image of the display screen peripheral circuit and the defect detection result into the defect detection model to optimize the defect detection model, etc.

Specifically, as an example, when it is determined that the display screen peripheral circuit corresponding to the image of the display screen peripheral circuit is a damaged circuit according to the defect detection result, that is, there is a defect in the display screen peripheral circuit, an alarm message may be issued to enable the production manager to locate the type and position of the defect in time, and provide a solution.

As another example, when it is determined that there is a defect in the display screen peripheral circuit according to the defect detection result, the defect detection result may be stored into the production database as a log through the controller, that is, the type of the defect in the display screen peripheral circuit, and/or the marquee position of the defect is stored into the production database as a log, which can further be filtered into the training database, the training module (which may be a software program such as a training engine) may update the defect detection model according to the image of the display screen peripheral circuit having a defect.

As still another example, when it is determined that there is a defect in the display screen peripheral circuit according to the defect detection result, the controller may also send a production control instruction to the console to eliminate the defect. That is, the detection model server carrying the defect detection model can determine the cause of the defect through the controller, and then adjust the production process correspondingly, also that is, the detection model server sends a production control instruction to the console through the controller to eliminate defects occurring on the display screen peripheral circuit to reduce the probability of damaged circuit.

As still another example, when it is determined that there is a defect in the display screen peripheral circuit according to the defect detection result, the image of the display screen peripheral circuit and the defect detection result may be directly input into the defect detection model to optimize the defect detection model, that is, the image of the display screen peripheral circuit corresponding to the damaged circuit is directly used as a training set of the defect detection model to optimize the defect detection model, thereby improving the detection accuracy of the defect detection model.

It is worth noting that, the embodiment of the present disclosure is not limited to one or more operations performed by the detection model server when determined that the display screen peripheral circuit is a damaged circuit, which may be determined according to actual conditions, and details are not described herein again.

In an embodiment, for a variety of different devices such as the image capturing device, the console, the server group, the controller, the database, etc. deployed on the production line of the display screen peripheral circuit, the method for detecting the display screen peripheral circuit may also be performed by distributing the corresponding operation steps to the plurality of different devices. For example, the image capturing device captures an image of the display screen peripheral circuit, and the console sends the image of the display screen peripheral circuit captured by the image capturing device to the detection model server in the server group according to the load balancing policy, after performing pre-set preprocessing on the image of the display screen peripheral circuit by the defect detection model running on the detection model server, performing defect detection, and then giving the defect detection result. The detection model server can send the defect detection result to the controller, on one hand, the controller combines an actual business scene, and according to the service requirement, and a response corresponding to the actual business scene requirement is generated according to the defect detection result, such as alarming, storage log, and control production control instructions, etc., on the other hand, the controller may further store the defect detection result and a processing behavior of the response into the production database as a log, so that the training module updates the obtained defect detection model according to the image of the display screen peripheral circuit and the defect detection result in the training database, the training database stores data such as an image of the display screen peripheral circuit with defect and corresponding defect detection results filtered from the production database.

It is worth noting that, for each optimized defect detection model, the defect detection model running on the server can be gradually replaced by the small traffic on-line, so as to achieve a purpose of the defect detection model dynamically expanding with the business scene and the production stage information. In the embodiment of the present disclosure, after the method for detecting the display screen peripheral circuit is run for a period of time on the production line of the display screen peripheral circuit, the accuracy of the defect detection and defect location can be reviewed manually through the information in the production database, then the training database is updated, and the defect detection model is retrained to improve the defect detection accuracy.

Following is an embodiment of the apparatus of the present disclosure, which can be used to perform the method embodiment of the present disclosure. For details not disclosed in the embodiment of the apparatus of the present disclosure, please refer to the method embodiment of the present disclosure.

FIG. 4 is a schematic structural diagram of an embodiment of an apparatus for detecting a display screen peripheral circuit according to an embodiment of the present disclosure. As shown in FIG. 4, the apparatus for detecting a display screen peripheral circuit provided by the embodiment of the present disclosure may mainly include: a receiving module 41, a preprocessing module 42, a processing module 43, and a determining module 44.

the receiving module 41, configured to receive a quality detection request sent by a console deployed on a production line of the display screen peripheral circuit, where the quality detection request includes an image of the display screen peripheral circuit captured by an image capturing device on the production line of the display screen peripheral circuit.

the preprocessing module 42, configured to enlarge or reduce the image of the display screen peripheral circuit to obtain an image to be detected, where a size of the image to be detected is consistent with an input size requirement of a defect detection model, where the defect detection model is obtained by using a historical image of a defective display screen peripheral circuit to perform object detection FAST RCNN algorithm training

the processing module 43, configured to input the image to be detected into the defect detection model to obtain a defect detection result.

the determining module 44, configured to determine, according to the defect detection result, quality of the display screen peripheral circuit corresponding to the image of the display screen peripheral circuit.

The apparatus for detecting the display screen peripheral circuit of the embodiment shown in FIG. 4 is correspondingly used to perform steps in the method embodiment shown in FIG. 2, and the implementation principle and technical effects are similar, and details are not described herein again.

In an embodiment, the processing module 43 is further configured to, before the inputting the image to be detected into the defect detection model to obtain the defect detection result, perform the FAST RCNN algorithm training on the defect detection model with an actual type of the historical image of the defective display screen peripheral circuit, so that a loss value between a prediction type which is outputted by the defect detection model for the historical image of the defective display screen peripheral circuit and the actual type is lower than a preset loss threshold.

In an embodiment, the preprocessing module 42 is configured to, before the enlarging or reducing the image of the display screen peripheral circuit, perform image preprocessing on the image of the display screen peripheral circuit, where the image preprocessing includes one or more of following processes: trimming, cutting, and rotating.

In an embodiment, the processing module 43 is specifically configured to determine a detection model server carrying a processing resource according to a load balancing policy; and input the image to be detected into the defect detection model running on the detection model server to obtain a defect detection result.

In an embodiment, the defect detection result includes: a type of a defect, and/or a marquee position of a defect.

The determining module 44 is specifically configured to determine, according to production stage information and the defect detection result, quality of the display screen peripheral circuit corresponding to the image of the display screen peripheral circuit.

In an embodiment, the processing module 43 is configured to, after determining, according to the defect detection result, quality of the display screen peripheral circuit corresponding to the image of the display screen peripheral circuit, if it is determined that the display screen peripheral circuit is a damaged circuit, perform one or more of following operations:

sending, through a controller, alarm information to a production manager;

storing, through the controller, the defect detection result in a production database as a log;

sending, through the controller, a production control instruction to the console to eliminate a defect;

inputting the image of the display screen peripheral circuit and the defect detection result into the defect detection model to optimize the defect detection model.

The apparatus for detecting the display screen peripheral circuit of the apparatus embodiment may be used to implement the implementation of the method embodiment shown in FIG. 2 to FIG. 3, and specific implementation and technical effects are similar, and details are not described herein again.

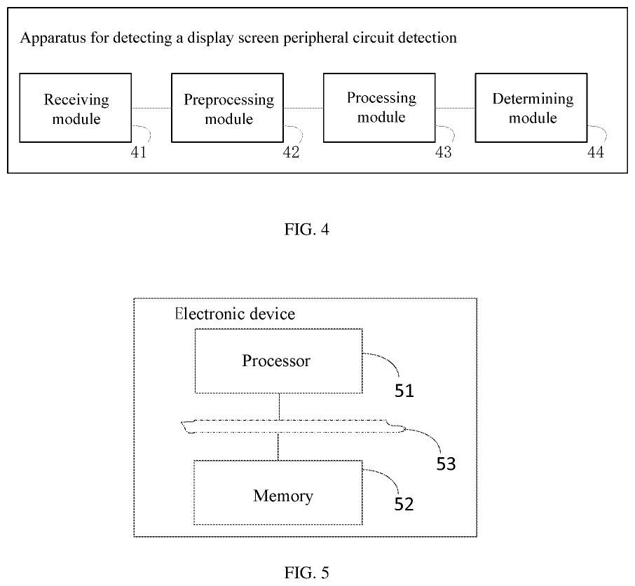

FIG. 5 is a schematic structural diagram of an embodiment of an electronic device according to an embodiment of the present disclosure. The electronic device includes: a processor 51, a memory 52, and a computer program; where

the memory 52 is configured to store the computer program, and the memory may also be a flash, the computer program is, for example, an application program and a function module that implement the foregoing method.

The processor 51 is configured to execute the computer program stored in the memory to implement various steps performed by the electronic device in the foregoing method. For details, refer to the related description in the foregoing method embodiment.

In an embodiment, the memory 52 can be either independent or integrated with the processor 51.

When the memory 52 is a device independent of the processor 51, the electronic device may further include:

a bus 53, configured to connect the memory 52 and the processor 51.

The present disclosure also provides a storage medium, where the storage medium stores an instruction which, when runs on a computer, causes the computer to perform the methods of the method embodiments shown in FIG. 2-3.

The storage medium may be a computer storage medium or a communication medium. The communication medium includes any medium that facilitates transfer of a computer program from one position to another. The computer storage medium can be any available media that can be accessed by a general purpose or special purpose computer. For example, the storage medium is coupled to the processor, such that the processor can read information from the readable storage medium and can write information to the storage medium. Of course, the storage medium may also be an integral part of the processor. The processor and the storage medium may be located in an Application Specific Integrated Circuits (ASIC). In addition, the ASIC can be located in a user equipment. Of course, the processor and the storage medium can also exist as discrete components in the communication device.

The present disclosure also provides a program product, the program product includes a computer program, the computer program being stored in a storage medium. At least one processor of the apparatus for detecting the display screen peripheral circuit can read the computer program from the storage medium, and the at least one processor executes the computer program such that the apparatus for detecting the display screen peripheral circuit performs the method embodiments of FIGS. 2 to 3.

In the embodiments of the electronic device, it should be understood that the processor may be a Central Processing Unit (CPU), or may be other general-purpose processor, a Digital Signal Processor (DSP), an Application Specific Integrated Circuit (ASIC) etc. The general-purpose processor may be a microprocessor or any conventional processor, etc. The steps of the method disclosed in the embodiments of the present application may be directly implemented by a hardware processor, or implemented by a combination of hardware and software modules in the processor.

Finally, it should be noted that the embodiments are only used to explain the technical solutions of the present disclosure, but not to limit; although the present disclosure has been described in detail with reference to the foregoing embodiments, those skilled in the art should understand that the technical solutions described in the foregoing embodiments may be modified, or some or all of the technical features may be equivalently replaced; however, these modifications or substitutions do not make the essence of corresponding technical solutions depart from of the scope of the embodiments of the present disclosure.

What is claimed is:

1. A method for detecting a display screen peripheral circuit, comprising:
receiving a quality detection request sent by a console deployed on a production line of the display screen peripheral circuit, wherein the quality detection request comprises an image of the display screen peripheral circuit captured by an image capturing device on the production line of the display screen peripheral circuit;
enlarging or reducing the image of the display screen peripheral circuit to obtain an image to be detected, wherein a size of the image to be detected is consistent with an input size requirement of a defect detection model, wherein the defect detection model is obtained by using a historical image of a defective display screen peripheral circuit to perform object detection FAST RCNN algorithm training;
inputting the image to be detected into the defect detection model to obtain a defect detection result; and
determining, according to the defect detection result, quality of the display screen peripheral circuit corresponding to the image of the display screen peripheral circuit.

2. The method according to claim 1, wherein before the inputting the image to be detected into the defect detection model to obtain a defect detection result, further comprising:
performing the FAST RCNN algorithm training on the defect detection model with an actual type of the historical image of the defective display screen peripheral circuit, so that a loss value between a prediction type which is outputted by the defect detection model for the historical image of the defective display screen peripheral circuit and the actual type is lower than a preset loss threshold.

3. The method according to claim 1, wherein before the enlarging or reducing the image of the display screen peripheral circuit, further comprising:
performing image preprocessing on the image of the display screen peripheral circuit, wherein the image preprocessing comprises one or more of following processes:
trimming, cutting, and rotating.

4. The method according to claim 1, wherein the inputting the image to be detected into the defect detection model to obtain a defect detection result, comprises:
determining a detection model server carrying a processing resource according to a load balancing policy; and
inputting the image to be detected into the defect detection model running on the detection model server to obtain a defect detection result.

5. The method according to claim 1, wherein the defect detection result comprises a type of a defect, and/or a marquee position of a defect;
the determining, according to the defect detection result, quality of the display screen peripheral circuit corresponding to the image of the display screen peripheral circuit, comprises:
determining, according to production stage information and the defect detection result, quality of the display screen peripheral circuit corresponding to the image of the display screen peripheral circuit.

6. The method according to claim 1, wherein after the determining, according to the defect detection result, quality of the display screen peripheral circuit corresponding to the image of the display screen peripheral circuit, further comprising:
if it is determined that the display screen peripheral circuit is a damaged circuit, performing one or more of following operations:
sending, through a controller, alarm information to a production manager;
storing, through the controller, the defect detection result in a production database as a log;
sending, through the controller, a production control instruction to the console to eliminate a defect; and
inputting the image of the display screen peripheral circuit and the defect detection result into the defect detection model to optimize the defect detection model.

7. An apparatus for detecting a display screen peripheral circuit detection, comprising: a processor, a memory, and a computer program stored on the memory and executable on the processor, wherein the processor executes the program to:
receive a quality detection request sent by a console deployed on a production line of the display screen peripheral circuit, wherein the quality detection request comprises an image of the display screen peripheral circuit captured by an image capturing device on the production line of the display screen peripheral circuit;
enlarge or reduce the image of the display screen peripheral circuit to obtain an image to be detected, wherein a size of the image to be detected is consistent with an input size requirement of a defect detection model, wherein the defect detection model is obtained by using a historical image of a defective display screen peripheral circuit to perform object detection FAST RCNN algorithm training;
input the image to be detected into the defect detection model to obtain a defect detection result; and
determine, according to the defect detection result, quality of the display screen peripheral circuit corresponding to the image of the display screen peripheral circuit.

8. The apparatus according to claim 7, wherein the processor executes the program further to, before the inputting the image to be detected into the defect detection model to obtain a defect detection result, perform the FAST RCNN algorithm training on the defect detection model with an actual type of the historical image of the defective display screen peripheral circuit, so that a loss value between a prediction type which is outputted by the defect detection model for the historical image of the defective display screen peripheral circuit and the actual type is lower than a preset loss threshold.

9. The apparatus according to claim 7, wherein the processor executes the program further to, before the enlarging or reducing the image of the display screen peripheral circuit, perform image preprocessing on the image of the display screen peripheral circuit, wherein the image preprocessing comprises one or more of following processes: trimming, cutting, and rotating.

10. The apparatus according to claim 7, wherein the processor executes the program to, determine a detection model server carrying a processing resource according to a load balancing policy; and input the image to be detected into the defect detection model running on the detection model server to obtain a defect detection result.

11. The apparatus according to claim 7, wherein the defect detection result comprises a type of a defect, and/or a marquee position of a defect;
the processor executes the program to: determine, according to production stage information and the defect detection result, quality of the display screen peripheral circuit corresponding to the image of the display screen peripheral circuit.

12. The apparatus according to claim 7, wherein the processor executes the program further to: after the determining, according to the defect detection result, quality of a display screen peripheral circuit corresponding to the image of the display screen peripheral circuit, if it is determined that the display screen peripheral circuit is a damaged circuit, perform one or more of following operations:
sending, through a controller, alarm information to a production manager;
storing, through the controller, the defect detection result in a production database as a log;
sending, through the controller, a production control instruction to the console to eliminate a defect;
inputting the image of the display screen peripheral circuit and the defect detection result into the defect detection model to optimize the defect detection model.

13. A storage medium, wherein the storage medium stores an instruction which, when run on a computer, causes the computer to implement the method according to claim 1.
